(19) United States
(12) Patent Application Publication
(10) Pub. No.: US 2012/0318874 A1
(43) Pub. Date: Dec. 20, 2012

(54) TRANSPONDER LABEL AND PRODUCTION METHOD FOR A TRANSPONDER LABEL

(75) Inventors: Thomas GERMANN, Muenchen (DE); Gerhard HOELZL, Fahrenzhausen (DE); Volker HUFNAGEL, Herrsching (DE)

(73) Assignee: SCHREINER GROUP GMBH & CO. KG, Oberschleissheim (DE)

(21) Appl. No.: 13/495,203

(22) Filed: Jun. 13, 2012

(30) Foreign Application Priority Data
Jun. 14, 2011 (DE) 10 2011 104 170.6

(51) Int. Cl. G06K 19/07; B32B 38/00

(52) U.S. Cl. 235/492; 156/227

(57) ABSTRACT

A transponder label for a metallic substrate, which is relatively thin and flexible, and a cost-advantageous roll-to-roll production method for such transponder labels. A transponder inlay having a chip and an antenna is applied to the foam material element in such a manner that a first part of the antenna is situated on the top of the foam material element and a second part of the antenna is situated on the underside of the foam material element.

### CROSS REFERENCE TO RELATED APPLICATIONS

Applicants claim priority under 35 U.S.C. §119 of German Application No. 10 2011 104 170.6 filed Jun. 14, 2011, the disclosure of which is incorporated by reference.

### BACKGROUND OF THE INVENTION

1. Field of the Invention

The present invention relates to a transponder label and to a production method for a transponder label. In particular, the present invention relates to a transponder label for use on a metallic surface, as well as to a method with which such transponder labels can be produced efficiently.

2. The Prior Art

Suitable identification of individual goods is gaining ever greater importance in controlling the flow of goods. Because control of the goods flows takes place semi-automatically or fully automatically, it is necessary for the individual goods to be detected automatically both with incoming goods and outgoing goods. Only in this way can modern logistics or warehouse management be implemented in an automated or computer-assisted manner.

For this purpose, optical identification in the form of one-dimensional barcodes or two-dimensional data matrix codes are used, among other things. These can be detected relatively quickly, by means of an optical reading device, and processed further electronically. However, it is necessary for the optical identification to be situated on the outside of each individual goods element and be easily readable. Furthermore, in this manner, only one product at a time can be sequentially detected. This leads to a relatively long time period for detection, particularly with a great number of units.

In recent times, what are called RFID elements (RFID=Radio Frequency IDentification) have gained increasing attention as an alternative for identification. Such elements (transponders) possess an integrated semiconductor chip (IC) on which the electronic information can be stored, as well as an antenna by way of which the stored information can be transmitted to a reading and writing device, in a wireless manner.

Because of the wireless transmission between transponder and reading device, such an identification element can also be situated in the interior of a product, or the product itself can be surrounded by a non-transparent packaging. Furthermore, this method also offers the possibility of detecting a very great number of identifications within the shortest possible period of time.

Because electromagnetic waves are required for the data exchange between transponder and reading device, the data exchange can be negatively influenced by electrically conductive components. In particular, if the transponder has to be applied to a metal surface, the data exchange can be made more difficult or even impossible.

For this reason, very particular transponder solutions are required for goods having metallic components. For example, the transponder element can be applied to a paper or plastic support, and the support can be glued onto the metal surface as a kind of projecting flag (“flag tag”). However, under some circumstances, such projecting flags can easily be ripped off or damaged, and this would lead to a loss of the identification.

Alternatively, a conventional transponder label can be applied to a spacer, for example made of plastic. The combination of spacer and transponder label is then glued onto the metal surface. However, in practice, such solutions bring only relatively unsatisfactory reading ranges and take up a comparatively large space.

Another possibility is transponder elements that are completely enclosed with an electrically non-conductive material (“hard tags”). Such a mantle serves as a spacer between the metal surface of the goods and the RFID transponder, on the one hand, and as protection against mechanical stress, on the other hand. However, such solutions are also very expensive and therefore unsuitable for use in large numbers of units.

### SUMMARY OF THE INVENTION

It therefore an object of the present invention to provide a transponder label that can be produced cost-advantageously and that possesses very good transmission and reception properties on a metallic object.

This object is accomplished by a transponder label that comprises a dielectric foam material element having a top and an underside, and a transponder inlay having a chip and an antenna. The transponder inlay is applied to the foam material element in such a manner that a first part of the antenna is situated on the top of the foam material element and a second part of the antenna is situated on the underside of the foam material element.

Furthermore, this object is also accomplished by a production method for a transponder label, which comprises the following steps: providing a dielectric foam material web having a top and an underside; providing a transponder inlay comprising a chip and an antenna; applying the transponder inlay to the foam material web in such a manner that a first part of the antenna is situated on the top of the foam material web; folding the transponder inlay around the foam material web in such a manner that a second part of the antenna comes to lie on the underside of the foam material web; and applying an adhesive to the underside of the foam material web and the second part of the antenna.

It is an approach of the present invention to affix a conventional transponder inlay around a foam material support, so that the foam material support can be made available in a very simple manner, as a material web, from a roll, onto which web the conventional transponder inlay is applied and folded around. After application of an adhesive and covering of the adhesive with a liner (protective film), the transponder labels produced in this manner can either be separated immediately, or the complete material web can be rolled up again onto a new roll.

In this connection, providing the foam material and the liner from a roll and using conventional transponder labels having an antenna allows very efficient and therefore cost-advantageous production of the transponder labels according to the invention. Thus the production costs can be clearly lowered, as compared with alternative products.

A strip conductor antenna is formed by the antenna folded around the foam material. In this connection, the foam material serves as a dielectric. One part of the antenna is disposed on the top and another part is disposed on the underside of the foam material. Thus, a strip conductor is formed, which forms a dielectric resonator if the dimensions are suitable. In this connection, the dimension of the antenna is related to the frequency used by the system. In particular, the antenna is a strip conductor antenna using the lambda/4 structure.

Preferably, the foam material element possesses a maximum thickness of 1.5 millimeters. In this way, very particularly thin transponder labels can be produced, which nevertheless possess an excellent reading range on electrically conductive substrata.

In a preferred embodiment, the transponder label furthermore comprises a first film element that covers at least a partial region of the transponder inlay. Particularly preferably, the transponder label furthermore comprises a second film element that covers at least a partial region of the transponder inlay. These film elements offer good possibilities for visual identification of the transponder label, and also represent protection against contamination and possible damage.

In a special embodiment, the transponder label comprises an adhesive coating that covers at least a partial region of the underside of the foam material element and of the second part of the antenna. Therefore the label can be glued onto a product to be identified, in a simple manner.

Preferably, such a transponder label furthermore comprises an adhesive covering that covers the adhesive coating on the underside of the foam material element and the second part of the antenna.

The production method according to the invention preferably comprises a step for applying a first film element onto at least a partial region of the transponder inlay. Particularly preferably, the method furthermore comprises a step for applying a further film element onto the top of the first film element having the first part of the antenna.

In an alternative embodiment, the method furthermore comprises a step for applying a protective film to the underside of the foam material web and the second part of the antenna.

Preferably, the production method furthermore comprises a step for punching individual transponder labels out of the foam material web having multiple transponder inlays applied to it and folded over.

Alternatively, in a special embodiment, the production method furthermore comprises a step of winding up a material web composed of the foam material web with multiple transponder inlays applied to it and folded over.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic cross-section through a transponder label according to the invention;

FIGS. 2a to 2c show schematic cross-sections through transponder labels according to the invention, having different upper laminate variants;

FIG. 3 shows a schematic representation of a production process for a transponder label according to the invention; and

FIG. 4 shows a schematic representation of a processing step for the production of a transponder label according to the invention.

### DETAILED DESCRIPTION OF THE PREFERRED EMBODIMENT

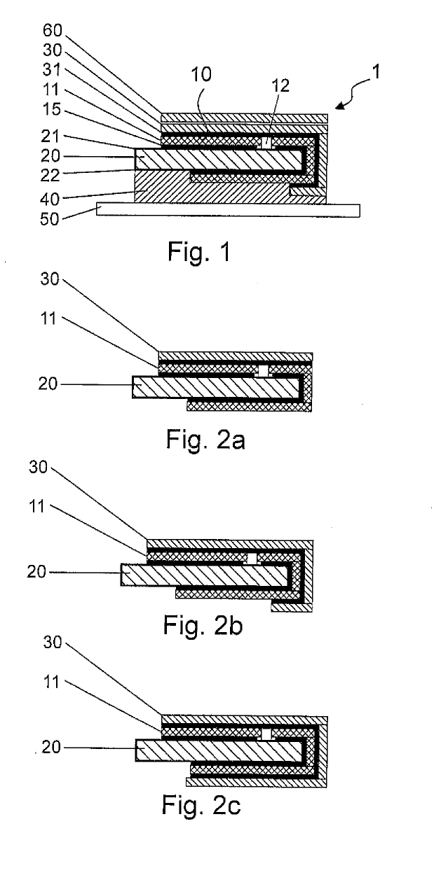

Referring now in detail to the drawings, FIG. 1 shows a cross-section through a transponder label 1 according to the invention. In the center of the label 1, a foam material 20 composed of an electrically insulating, dielectric material is disposed. This foam material 20 usually has a material thickness of 2 mm or less. Preferably, the foam material 20 possesses a thickness of maximally 1.5 mm, particularly preferably a thickness of 1.2 mm. An embodiment of a foam material comprises a polymer material in which a cell structure is formed. The cells can be open or closed cells. The foam material is therefore compressible.

A transponder inlay 10 is affixed around the foam material 20, i.e. on the top, the underside, and side edges of the foam material 20. This transponder inlay 10 comprises at least one antenna 11 and one chip 12.

In this connection, the transponder inlay 10 is affixed to the foam material 20 in such a manner that the chip 12 is situated on the top 21 of the foam material 20. In this connection, the top 21 is understood to mean the side of the foam material 20 that faces away from the metal surface in the case of application of the complete label to a metal surface. Accordingly, the side of the foam material 20 that faces the metal surface in the case of application of the label is referred to as the underside 22.

In this connection, the transponder inlay 10 is preferably applied to the foam material 20 in such a manner that the chip 12, seen from the transponder inlay 10, faces the foam material 20. Therefore the chip 12 is protected from damage particularly well by the foam material 20. Alternatively, the transponder inlay 10 can also be applied in such a manner that the chip 12 faces outward. Therefore even better performance (reading range) can be achieved.

One part of the antenna 11 of the transponder inlay 10 is affixed to the top 21 of the foam material 20. Another part of the antenna 11 is folded around the foam material 20 and comes to lie on the underside 22 of the foam material.

In the applied state, the two parts of the antenna 11 on the top 21 and the underside 22 of the foam material 20 run parallel to one another. The chip 12 is disposed between the two parts of the antenna. Due to this arrangement, a strip antenna is formed, for example. Such a strip antenna is a dielectric resonator that is configured as a dielectric, from the two electrically conductive antenna parts 11 and the foam material 20 that is disposed between them.

In this connection, the expanse of the antenna surface in a direction parallel to the top 21 and underside 22 of the foam material 20 amounts to about one-fourth of the wavelength of the operating frequency. This antenna type is also referred to as a lambda/4 antenna.

In this connection, the strip conductor antenna 11 is connected with the foam material 20 by means of an adhesive. Preferably, in this connection, the adhesive has already been applied to the foam material 20 previously. In this way, a self-adhesive foam material 20 is obtained. This self-adhesive foam material 20 is then applied to a non-adhesive transponder inlay 10. Alternatively, however, it would also be possible to apply the adhesive to the transponder inlay 10 and to subsequently apply the self-adhesive transponder inlay 10 to a non-adhesive foam material 20.

For protection of the transponder inlay 10 and, in particular, of the chip 12, a protective laminate 30 is applied at least over a part of the transponder inlay 10 that is situated on the top of the foam material 20. This protective laminate 30 can be, a transparent film that is glued on, for example. In this connection, the protective laminate 30 can either be provided with an adhesive previously, or is applied in a separate step and subsequently a non-adhesive laminate is applied.

An alternative, in which the protective laminate is applied only to the top of the transponder label, is shown in FIG. 2a. The protective laminate 30 can also extend further over one side of the foam material 20 and a part of the underside 22, as shown in FIG. 2b, as an example. Alternatively, the protective laminate 30 can cover the full area of the underside 22, as shown in FIG. 2c.

The underside of the label 1 is provided with an adhesive 40 for attachment of the transponder label 1 that has been formed in this way on a preferably metallic substratum. This adhesive extends both over the free regions of the underside 22 of the foam element 20 and over the region of the strip conductor antenna 11 situated on the underside and, if applicable, the part of the protective laminate 30 situated on the underside.

In general, this adhesive 40 will not possess any electrically conductive properties, so that galvanic separation exists between strip conductor antenna 11 and a metallic, electrically conductive substratum. In this case, capacitative coupling takes place between strip conductor antenna 11 and the metallic substratum.

Alternatively, it would also be possible to use an electrically conductive adhesive, so that the strip conductor antenna 11 and the metallic substratum are connected with one another in electrically conductive manner. In this way, these transmission and reception properties of the transponder label 1 can be additionally improved.

For protection of the adhesive 40, the adhesive 40 is covered with a covering web 50, called a liner. In this connection, the liner 50 can consist of an elongated, strip-shaped web on which multiple transponder labels 1 are situated disposed next to one another. The liner 50 can consist either of a plastic film, or also of a paper web, onto which an adhesive-repelling substance is applied, if necessary.

For increased manipulation protection, the antenna 11 can be provided with suitable punched areas, for example in the form of a perforation, on the underside of the label. If a strongly adhering adhesive 40 is then used to connect the label with the substratum, then the strip conductor antenna 11 will tear off along the punched areas if an attempt is made to remove it, and the antenna structure will be put out of tune.

In this connection, it is possible that the antenna 11 is put out of tune so greatly that further reading of the transponder label is made completely impossible, and the label becomes incapable of functioning as a result. Alternatively, however, it is also possible that the punched areas are applied in such a manner that the antenna is only slightly put out of tune, and therefore further reading of the transponder at a significantly changed, preferably restricted reading range is possible. In this way, a manipulation attempt can be reliably detected, without the stored data being irretrievably lost.

For optical identification of the transponder label 1, the protective laminate 30 can be provided with an imprint. In this connection, not only a uniform imprint for a complete batch of transponder labels but also individual identification for each individual transponder label is possible. If the identification of a label is supposed to take place using the printing method, opaque films or transparent films having an opaque primer are suitable for obtaining good contrast with the imprint.

In order to protect the imprint of the identification from contaminants or damage, it is possible to apply an additional, further transparent protective laminate 60 over the imprint.

In this special structure, a film that can subsequently be written on with a laser can also be applied to the top of the transponder label 1 for identification of the transponder labels. In this connection, this is a film structure in which a color change or another optical change can be brought about by means of the irradiation with laser light.

Such films that can be written on with a laser generally possess a high proportion of metallic particles. The electrical conductivity of these metallic particles leads to a greatly restricted reading range in the case of conventional transponder labels, and generally makes reading or writing almost impossible. With the particular structure of the transponder labels according to the invention, however, a significant improvement in this reading range can be observed. In this way, it becomes possible for the first time to combine a film structure that can be written on with a laser with a transponder label.

In this connection, the identification film that can be written on with a laser can be applied above the protective laminate 30. Alternatively, an identification film that can be written on with a laser can also be applied first, directly to the antenna 11, and subsequently a transparent protective laminate 30 can be applied over the common structure. Furthermore, it is also possible that the identification film that can be written on with a laser simultaneously serves as the protective laminate.

By means of the combination of a transponder label described above with an identification film that can be written on with a laser, one obtains a transponder label that can be individually written on even at a later point in time and nevertheless possesses a good reading range, particularly in the case of application of the transponder label to a metallic substratum.

Because of these particular properties, it is also possible to use materials having a metal component for the identification of the transponder label, something that was not possible for transponder labels otherwise. In particular, what are called hologram films can also be used, for example. These films are very frequently used for forgery protection and proof of no tampering. Because a metallic foil is usually required for the hologram, it was not possible until now to combine such hologram films with transponder labels in a very small space and in such a flat structure.

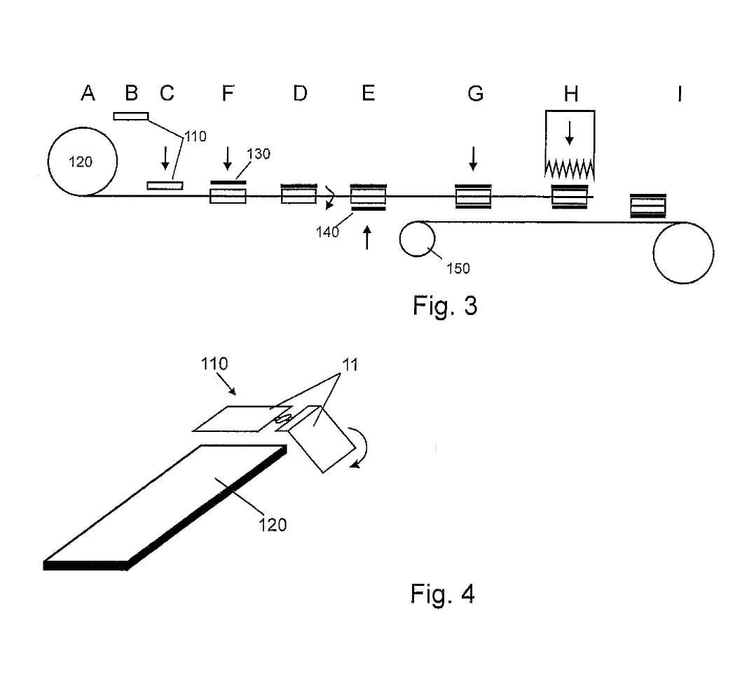

FIG. 3 shows an exemplary production process for a transponder label 1 according to the invention. First, a suitable foam material web 120 is made available. Preferably, in Step A, the foam material web 120 is made available as rolled goods and unrolled from this roll for production of the foam material web 120.

Next, in Step B, a suitable transponder inlay 110 is made available. As was already mentioned above, this transponder inlay 110 can previously be provided with an adhesive 15. However, if the transponder inlay 110 is not adhesive, a suitable adhesive must first be applied to the transponder inlay 110 or to parts of the foam material web 120.

Subsequently, in Step C, the transponder inlay 110 is applied to the foam material web 120 in such a manner that part of the antenna 11 and the chip 12 of the transponder inlay 110 come to lie on the top of the foam material web 120.

If the transponder label 1 is supposed to receive an optical identification, then a suitable identification element can be laminated onto a partial region of the transponder inlay 110 (in Step F, not shown in FIG. 3). For this purpose, this can be an imprinted film element or also a film element that can be written on with a laser, as has already been described above. Alternative identification elements can be applied in the same manner.

For protection of the transponder label, a preferably transparent protective laminate 130 can be applied to the transponder inlay 110 and, if applicable, also to the identification element described above, in a further step. Preferably, this is a transparent plastic film that is connected with the transponder label by means of adhesive.

In a next Step D, the remaining part of the antenna 11 that projects beyond the foam material web 120 is folded around the foam material web 120, so that this remaining part of the antenna 11 comes to lie on the underside of the foam material web and thus forms a strip conductor antenna. Folding of the transponder inlay around the foam material web is shown in detail in FIG. 4.

Subsequently, in Step 5, an adhesive 140, preferably a pressure-sensitive adhesive, is applied to the underside of the foam material web 120 with a part of the antenna 11 and possibly also a part of the protective laminate 130. This application can take place either over the full area, or ₜhe adhesive 140 is only applied in predefined regions of the underside. For example, the adhesive application can also be applied using a printing method.

For protection of the adhesive 140, this adhesive 140 is covered with a liner 150 in a further Step G, after application. For this purpose, this liner 150 is provided as a film web, preferably rolled up on a roll. This liner 150 is brought together with the underside of the foam material web 120 that has been provided with adhesive.

In this connection, the adhesive application E and the application G of the liner 150 can also take place in a common work step.

In a further Step H, an individual transponder label 1 is then punched out of the foam material web 120 with the transponder inlay 110. In this connection, the punch that punches out the individual transponder label can punch completely through the foam material 120 and also the liner 150, so that a direct, individual transponder label 1 is formed.

Alternatively, however, the punch can also penetrate only through the foam material 120 and leave the liner 150 undamaged as it does so. In this way, a continuous film web of the liner 150 is obtained, on which the punched-out transponder label 1 is situated. The part of the foam material web 120 that is not required can thereupon be removed, and this is referred to as weeding.

By means of the consecutive production of multiple such transponder labels 1, a film web of the liner 150 on which a plurality of transponder labels 1 are situated one behind the other is obtained. In a further Step I, this film web with the transponder labels 1 can then be rolled up and thereby conveniently made available for further processing as rolled goods.

In summary, this invention relates to a transponder label for a metallic substratum. In this connection, the transponder label is nevertheless relatively thin and flexible. The invention furthermore relates to a cost-advantageous roll-to-roll production method for such transponder labels.

Accordingly, while only a few embodiments of the present invention have been shown and described, it is obvious that many changes and modifications may be made thereunto without departing from the spirit and scope of the invention.

What is claimed is:

1. A transponder label comprising:
a dielectric foam material element having a top and an underside; and
a transponder inlay having a chip and an antenna;
wherein the transponder inlay is applied to the foam material element in such a manner that a first part of the antenna is situated on the top of the foam material element and a second part of the antenna is situated on the underside of the foam material element.

2. The transponder label according to claim 1, wherein the antenna is a strip conductor antenna.

3. The transponder label according to claim 1, wherein the foam material element possesses a maximum thickness of 1.5 mm.

4. The transponder label according to claim 1, furthermore comprising a first film element that covers at least a partial region of the transponder inlay.

5. The transponder label according to claim 4, furthermore comprising a second film element that covers at least a partial region of the first film element.

6. The transponder label according to claim 5, wherein the first or the second film element is a film element that is adapted to be written on with a laser.

7. The transponder label according to claim 1, further comprising an adhesive coating that covers at least a partial region of the underside of the foam material element and of the second part of the antenna.

8. The transponder label according to claim 4, wherein the first film element completely covers the antenna on the underside of the foam material element, and wherein a region of the first film element that comes to lie on the underside is provided with an adhesive coating over a full area of said region.

9. The transponder label according to claim 8, further comprising an adhesive covering that covers the adhesive coating on the underside of the foam material element and the second part of the antenna.

10. The transponder label according to claim 9, wherein the adhesive covering is a film web or paper web.

11. A production method for a transponder label, comprising:
providing a dielectric foam material web having a top and an underside;
providing a transponder inlay comprising a chip and an antenna;
applying the transponder inlay to the foam material web in such a manner that a first part of the antenna is situated on the top of the foam material web;
folding the transponder inlay around the foam material web in such a manner that a second part of the antenna comes to lie on the underside of the foam material web; and
applying an adhesive to the underside of the foam material web and the second part of the antenna.

12. The production method according to claim 11, further comprising the step of applying a first film element onto at least a partial region of the transponder inlay.

13. The production method according to claim 12, further comprising the step of applying a second film element onto the top of the foam material element having the first part of the antenna.

14. The production method according to claim 13, wherein the first or the second film element is a film element that is adapted to be written on with a laser.

15. The production method according to claim 13, wherein the second film element is a transparent protective film.

16. The production method according to claim 11, further comprising the step of applying a protective film to the underside of the foam material web and the second part of the antenna.

17. The production method according to claim 11, further comprising the step of applying multiple transponder inlays to the foam material web and punching individual transponder labels out of the foam material web.

18. The production method according to claim 11, wherein the foam material web has multiple transponder inlays applied to it and folded over, and further comprising the step of winding up the foam material web.
